(19) United States
(12) Patent Application Publication
(10) Pub. No.: US 2025/0020240 A1
(43) Pub. Date: Jan. 16, 2025

(54) FASTENING DEVICE AND SYSTEM FOR FIXATING AT LEAST ONE PIPE

(71) Applicant: Armacell Enterprise GmbH & Co. KG, Schönefeld OT Waltersdorf (DE)

(72) Inventor: Martin BOUDREAU, Québec (CA)

(21) Appl. No.: 18/710,954

(22) PCT Filed: Mar. 30, 2023
(86) PCT No.: PCT/EP2023/058226

§ 371 Date: May 16, 2024

(30) Foreign Application Priority Data
Mar. 30, 2022 (EP) 22165381.9

(51) Int. Cl. F16L 3/10

(52) U.S. Cl. CPC F16L 3/1075

(57) ABSTRACT

A fastening device is provided for fastening a pipe to a support structure. The fastening device includes a clamping device having at least two clamp segments rotatably connected to each other such that the clamping device is mountable and unmountable on a circumference of the pipe by rotating the clamp segments relative to each other. The fastening device further includes at least one thermal insulating element, wherein the thermal insulating element is arranged between the clamp segment and the pipe, the thermal insulating element being fixedly attached to the clamp segment. The fastening device further includes an attachment device configured to fixedly attach the fastening device to the support structure. A system for fixating at least one pipe is also provided.

Pipes are employed in a number of different environments and/or for a variety of purposes and/or applications, e.g., to transport different media, such as various types of liquids and/or gases. Pipes may be used in industrial applications, e.g., to transport liquids and/or gases to and/or from an industrial environment, such as a manufacturing environment. Pipes may also be employed in a civil and/or residential environment, e.g., for providing cooling and/or heating, for instance, in an atmosphere within a building. Besides transporting gases and liquids, pipes may also be used to transport solid, or at least partially solid, goods, such as granulates and/or powder. A combination of at least two of liquid, gas and solid media may also be transported by the pipes.

The pipes may be guided through one or more environments in order to transport the media between different locations, e.g., from a first location, such as from a source of the respective medium, to at least a second location, such as to a consuming device which consumes and/or utilizes the transported medium, and/or vice versa. The pipes are generally secured by means of one or more fastening devices in the respective environments, through which the medium is transported via the pipes, e.g., by mounting the pipes to an external support structure to support and/or fixate the pipes.

A number of challenges may be faced when installing pipes in the respective environment(s) for the respective purposes and/or application(s). For instance, the medium/media being transported in the pipes may have a temperature which is greater or lower than an ambient temperature which is prevalent in the respective environment(s) in which the pipes are installed and/or a temperature of the support structure(s) to which the pipe is secured via the respective fastening device.

Such a temperature gradient may cause thermal bridging between the pipe(s) and the support structure(s) to which the pipe(s) is/are secured via the respective fastening device. Thermal bridging may cause significant energy losses due to heat conduction, e.g., between the pipe(s) and the support structure(s) to which the pipe(s) is/are secured via the respective fastening device, for instance, when a relatively warm medium is transported through the pipes which run through a relatively cool environment and/or when a relatively cool medium is transported through the pipes which run through a relatively warm environment. Moreover, thermal bridging between the pipe(s) and the support structure may cause condensation on a surface of the fastening device and/or on a surface of the pipes and/or on a surface of one or more other components which may compromise the fastening device and/or other components and/or cause deterioration to the fastening device and/or surrounding components, e.g., due to one or more corrosive effects which the condensation may have on a material of the fastening device and/or the surrounding components.

Moreover, moisture buildup due to condensation may promote a buildup of microorganisms, such as bacteria and/or fungi, e.g., mold, which may cause adverse health effects and/or compromise and/or cause deterioration to the fastening device and/or surrounding components, such as by promoting rotting of the fastening device and/or surrounding components.

An application in which a relatively cool medium is transported through a pipe which runs through a relatively warm environment and/or in which the pipe transporting the relatively cool medium is attached to a relatively warm support structure via the respective fastening device may be particularly susceptible to such condensate formation, e.g., on and/or in the fastening device.

Corrosion and/or rotting of the fastening device may weaken the structural integrity of the fastening device which may lead to a failure of the fastening device which may result in damage to the pipes, and potentially to secondary damages, such as damage caused by a leak of the medium from the pipes to the environment.

Moreover, in most cases, installing the pipe(s) in the respective environments may be tedious and labor-intensive. Since in many cases a relatively large number of pipes may have to be installed in the respective environments, this may cause the installation efforts for installing said pipes to be undesirably high.

It is known to provide thermal insulation material in the pipe installation to mitigate thermal bridging between the pipe(s) and the support structure. However, including such thermal insulation material in the pipe installation is often cumbersome, in particular in view of the relatively high installation efforts for installing the pipes in general, as described above. Thus, there remains a need for further improving the installation of pipes.

It is therefore an object of the invention to provide a fastening means for fastening pipes which improves and/or facilitates the installation of the pipes.

This object is achieved by a fastening device which is defined by the features of claim 1. Preferred embodiments are defined by the features of the respective dependent claims.

The fastening device may be configured to fasten at least one pipe to at least one support structure. The fastening device may be configured to be at least partially, preferably slidably, received in at least a section of the support structure. For this purpose, the support structure may include a groove formed therein, the groove being configured to at least partially, preferably slidably, receive at least a portion of the fastening device. The support structure preferably includes a rail or rail-like structure, such as a strut. The support structure may be configured to at least partially delimit an environment in which the pipe and the fastening device are arranged, such as a ceiling, a wall or a floor of a room, e.g., of a building, and/or may be connected to a structure which at least partially delimits an environment in which the pipe and the fastening device are arranged, such as a ceiling, a wall or a floor of a room, e.g., of a building. The fastening device may be configured to prevent, or at least limit, movement of the pipe in one or more degrees of freedom, such as one or more translational and/or rotational degrees of freedom of the pipe. Thus, the fastening device may be configured to maintain the pipe in a substantially stationary state.

The pipe may be made of a variety of different materials, such as metal, e.g., copper, brass, steel or aluminium. The pipe may alternatively be made of plastic, e.g., polyvinyl chloride (PVC), ceramic, glass or a composite material, such as including fiberglass or carbon fiber. The pipe may have a wall which defines and at least partially encompasses a media transportation space therein, in which the various media may be transported along a direction of transportation. The wall may have an interior surface, which may be in contact with the medium/media being transported in the pipe, and an exterior surface, which faces away from the interior surface.

The pipe may have a variety of different dimensions and/or shapes. For instance, the pipe may have a circular or a polygonal, e.g., a square or pentagonal shape, circumference in a cross-sectional view. The media transportation space of the pipe may have various cross-sectional areas for transporting the respective medium/media. The pipe may be configured to transport a variety of different types of media, e.g., gas, liquid and/or solid media. The pipe may be configured to transport different types of media simultaneously and/or sequentially. For instance, the pipe may be configured to transport a gas and a liquid simultaneously and/or sequentially. The pipe may be configured to transport a medium which may at least partially change its phase, e.g., liquid to gas and/or vice versa, during transportation and/or in between transportation through the pipe. For instance, the pipe may be configured to transport a refrigerant which may be at least partially condensed and/or evaporated in the pipe and/or in a separate device, e.g., in a condenser and evaporator, respectively, which may be arranged upstream or downstream of a section of the pipe to which the fastening device is secured. For instance, the pipe may be configured to transport a refrigerant in a gas and/or liquid phase in a heating, ventilation, and air conditioning (HVAC) application and/or a heating, ventilation, air conditioning and refrigeration (HVAC-R) application.

The pipe may be configured to transport one or more media which are pressurized at a variety of different pressure levels. Alternatively, or additionally, the pipe may be configured to transport one or more media having a range of different temperatures.

The fastening device may be configured to support at least a section of the pipe in a mounted state of the fastening device. The fastening device may be configured to support the pipe in an arrangement in which the pipe extends substantially horizontally, i.e., substantially perpendicularly to the direction of gravity, in a mounted state of the fastening device. Preferably, in such an arrangement the fastening surface supports the pipe by providing at least a support force which acts substantially against the direction of gravity. Thus, such a support force may provide support against the weight of the pipe itself and/or the weight of the medium/media being transported in the pipe, in an operative state of the pipe.

Alternatively, or additionally, the fastening device may be configured to support at least a section of the pipe in an arrangement in which the pipe extends substantially vertically, i.e., substantially along the direction of gravity, in a mounted state of the fastening device. Preferably, in such an arrangement the fastening device may provide at least a support force which acts substantially perpendicularly to the direction of gravity and/or a support force which acts substantially against the direction of gravity. In such an arrangement, the fastening device may provide support against lateral movement of the pipes, i.e., movement in a direction which is substantially perpendicular to a longitudinal axis of the pipe, the longitudinal axis preferably extending in the direction of transportation of the medium/media being transported in the pipe, when the pipe is in operation. Such lateral movement may be effected by an expansion of the medium/media being transported in the pipe and/or by vibration of the pipe. Moreover, in such an arrangement, the fastening device may provide support against the weight of the pipe itself and/or the weight of the medium/media being transported in the pipe, in an operative state of the pipe.

Alternatively, or additionally, the fastening device may be configured to support the pipe in an arrangement in which the pipe is oriented between a vertical and a horizontal orientation, e.g., in which the pipe extends at a 45° angle relative to a horizontal plane and/or a vertical plane.

The fastening device may be configured to fasten the pipe to a plurality of support structures and/or to a plurality of different sections of the same support structure. The fastening device may be configured to fasten a plurality of pipes or a plurality of sections of a pipe to the support structure.

The fastening device may include at least one clamping device having at least two clamp segments which are rotatably connected to each other such that the clamping device is mountable and unmountable on at least a portion of a circumference of the pipe by rotating the clamp segments relative to each other about a clamping device rotation axis. By configuring the clamp segments to be rotatably connected to each other, the clamp device may be handled and/or operated as a single coherent component, e.g., during mounting and unmounting of the clamping device. This may allow the clamp device to be operable single-handedly by a user. This may increase the user-friendliness of the fastening device described herein, e.g., by simplifying and/or reducing the efforts required for mounting and/or unmounting the fastening device, more specifically the clamp device. Moreover, by freeing one hand of the user, the user may utilize the free hand for other purposes, e.g., to stabilize the user's body during mounting and/or unmounting of the clamp device.

The fastening device may include at least one rotation element configured to enable the clamp segments to be rotated relative to each other about the clamping device rotation axis. The clamp segments may be configured as two separate components which are connected to each other, e.g., via at least one hinge element. Preferably, the clamp segments are removably connected to each other by means of at least one connection element, e.g., via at least one hinge element, such that the connection between the clamp segments may be released without substantially compromising the structural integrity of the clamp segments and the connection element. Alternatively, the clamp segments may be configured as a single integral and/or monolithic component, in which case at least one hinge element may also be integrated in the integral and/or monolithic component, e.g., as a flexible portion, e.g., a crease, a living hinge and/or a similar structural feature provided in a material of the integral component, to allow the clamp segments to be rotated relative to each other about the clamping device rotation axis at least at the hinge element.

Preferably, the clamp segments are rotatably connected to each other via at least one hinge, which is preferably integrated at least partially in at least one of the clamp segments. The hinge may be formed integrally with at least one of the clamp segments as a coherent and/or monolithic unit. Preferably, a first section of the hinge is integrated in a first of the clamp segments and a second section of the hinge is integrated in a second of the clamp segments. The hinge may be configured such that the first section is at least partially receivable in the second section of the hinge, wherein the first section of the hinge may be rotatable within and relative to the second section of the hinge to enable the clamp segments to be rotatable relative to each other.

The fastening device may include at least one locking element configured to maintain the clamp segments in a mounted or substantially closed state in which the clamp segments are positioned and clamped on at least a portion of a circumference of the pipe. The locking element may include at least one actuating element configured to be actuated by a user to unlock the locking element to allow the clamp segments to be rotated relative to each other about the clamping device rotation axis to allow the clamping device to be unmounted from the pipe.

The fastening device may further include at least one thermal insulating element made of a thermal insulating material configured to decrease a thermal transmittance of the fastening device. The thermal insulating element may be configured to reduce heat transfer, more specifically heat conduction, between the pipe and/or the support structure and/or between the pipe and an environment in which the pipe and/or the fastening device is arranged in a mounted state. The thermal insulating element may be configured to thermally isolate the pipe from the fastening device, more specifically from the clamp device. Although the present disclosure describes using a thermal insulating element made of a thermal insulating material, any insulating element may be used, such as an acoustic insulating element and/or an insulating element for preventing, or at least limiting, leakage from the pipe.

The thermal insulating element may be at least partially arranged between at least one of the clamp segments and at least a section of the pipe, when the fastening device, more specifically the clamping device, is mounted to the pipe. The thermal insulating element may be fixedly attached to at least one of the clamp segments. By fixedly attaching the thermal insulating element to at least one of the clamp segments, the thermal insulating element may be secured to the clamping device in a loss-proof manner, i.e., when the clamping device is in a mounted state and an unmounted state. Thus, the thermal insulating element may remain attached to the clamping device when the fastening device is unmounted from the pipe and/or when the clamp segments are moved, e.g., rotated, relative to each other. The thermal insulating element and the clamping device may thus be fixed relative to each other.

Thus, the thermal insulating element may be attached to the clamping device in an integrated manner such that the thermal insulating element and the clamping device may be configured as a single coherent unit which may be handled as such during mounting and/or unmounting of the fastening device. This may allow the the thermal insulating element to be securely pre-assembled to the clamping device prior to installation of the fastening device on the pipe and/or the support structure. This may further facilitate the mounting and/or unmounting of the fastening device since the user does not have to manually hold the the thermal insulating element and the clamping device in place relative to each other, e.g., during the mounting and/or unmounting process. Moreover, this may eliminate, or at least reduce, the risk of losing and/or dropping the thermal insulating element during mounting and/or unmounting of the fastening device on the pipe and/or the support structure. Moreover, by fixing the thermal insulating element and the clamping device relative to each other, a target position and/or a target orientation of the thermal insulating element relative to the clamping device may be achieved more accurately and/or more reliably and/or more easily and/or more intuitively.

The thermal insulating element may be fixedly attached to at least one of the clamp segments by means of at least one frictional connection and/or at least one form fit connection, such as an interference fit, and/or at least one material bond connection, such as an adhesive connection by means of at least one adhesive material. Preferably, the thermal insulating element and/or at least one of the clamp segments may include at least one attachment mechanism for attaching the thermal insulating element to at least one of the clamp segments.

The thermal insulating element may be configured to decrease the thermal transmittance of the fastening device, e.g., by having a relatively low thermal conductivity, e.g., with respect to a material of the pipe and/or the support structure, and/or by having a thickness sufficient for decreasing the thermal transmittance of the fastening device accordingly, e.g., to prevent, or at least limit, thermal bridging between the pipe and the support structure.

Preferably, the thermal insulating element has an annular or semi-annular shape, i.e., shaped as a ring segment, e.g., in order to at least partially encompass the pipe in a mounted state. The thermal insulating element may be configured as an insert, preferably an exchangeable insert, to allow a modular, or at least semi-modular, assembly of the fastening device, e.g., by enabling a variety different thermal insulating elements to be used with, e.g., assembled on, the same clamping device, e.g., for pipes with different diameters and/or different shapes and/or different standards for thermal insulation. For this purpose, the fastening device may be included in a kit with a plurality of interchangeable thermal insulating elements having different configurations, e.g., made of different materials and/or having one or more different dimensions and/or having different shapes. The clamping device may also be provided with different sizes and/or geometries and/or materials depending on the application.

A thickness of the thermal insulating element and/or an axial length of the thermal insulating element may be selected depending on the application and/or installation situation of the fastening device. Preferably, the thermal insulating element has a thickness from 5 mm to 50 mm, more preferably from 10 mm to 40 mm. Alternatively, the thermal insulating element may have a thickness which is greater than 50 mm.

The fastening device may further include at least one attachment device configured to fixedly attach the fastening device to the support structure. The attachment device may be configured to fixedly attach to the support structure by means of at least one frictional connection and/or at least one form fit connection, such as an interference fit, and/or at least one material bond connection, such as an adhesive connection by means of at least one adhesive material. However, the attachment device may be omitted. As an alternative, the fastening device may be attached or secured to the support structure by other means, e.g., by clamping the fastening device between two support structures or between two sections of the same support structure. Preferably, the attachment device is formed integrally and/or monolithically on the at least one of the clamp segments of the clamping device.

The attachment device may be configured to be at least partially received, preferably slidably received, in at least a section of the support structure. For this purpose, the support structure may include a groove formed therein configured to at least partially receive, preferably slidably receive, at least a portion of the fastening device.

The fastening device may include a plurality of attachment devices, e.g., at least two attachment devices, configured to fixedly attach the fastening device to a plurality of support structures or a plurality of sections of one or more support structures. Preferably, the fastening device includes at least two attachment devices which are arranged substantially opposite from each other, e.g., on substantially opposite ends of the fastening device.

The fastening device may include a plurality of attachment devices, preferably wherein at least two of the plurality of attachment devices have different attachment mechanisms for attaching to the support structure. For instance, a first attachment device may be configured to be at least partially received, preferably slidably received, in at least a section of the support structure, e.g., in a groove formed in at least a section of the support structure. The first attachment device may include a widened engaging element that provides an undercut and engages behind a portion of the support structure to hold the fastening device to the support structure. A second attachment device may be configured to abut and/or be pressed against a support structure, i.e., the same support structure to which the first attachment device is attached or a different support structure. The second attachment device may include an engaging portion, such as a pin, configured to be received, preferably slidably received, within the second support structure, e.g. in a groove or hole of the second support structure.

Preferably, at least one of the clamp segments has an attachment section which is integrally formed on the clamp segment. Preferably, each clamp segment has at least one attachment section. Preferably, the attachment section is configured to engage with at least a section of the thermal insulating element to fixedly attach the thermal insulating element to the clamp segment. The attachment section may provide a secure fixation of the thermal insulating element(s) on the respective clamp segment. Preferably, all of the clamp segments have such an attachment section.

Preferably, the attachment section includes at least one protrusion which protrudes from an inner surface of the clamp segment, the inner surface facing the pipe when the fastening device is mounted on the pipe. Preferably, each one clamp segment has at least one protrusion. The protrusion may be elongate in a direction along at least a section of the inner surface. The protrusion may be configured to engage with a recess, e.g., by being partially receivable in the recess, which is formed in at least a section of an outer surface of the thermal insulating element which faces the inner surface of the clamp segment, when the fastening device is mounted on the pipe, the recess preferably extending circumferentially along at least a section of the thermal insulating element, to attach the thermal insulating element to the clamp segment. By providing a connection between the clamp segment and the thermal insulating element via the protrusion and the recess, a sort of tongue-and-groove joint between the clamp segment and the thermal insulating element may be achieved which may result in a relatively secure and/or reliable connection therebetween. Moreover, such a connection may allow a position and/or an orientation of the thermal insulating element relative to the clamp segment to be adjusted and/or adapted if needed, e.g., to properly align and/or position the thermal insulating element relative to the clamp segment. Preferably, the protrusion and the recess are shaped and/or dimensioned such that the protrusion and the recess provide at least one frictional connection and/or at least one form fit connection, such as an interference fit. Additionally, or alternatively, the protrusion and the recess may be connected by means of at least one material bond connection, such as an adhesive connection by means of at least one adhesive material and/or an ultrasonically welded connection and/or a snap fit and/or a press fit.

Alternatively, or additionally, at least one protrusion which protrudes from an outer surface of the thermal insulating element may be provided. The protrusion may be configured to engage with a recess, e.g., by being partially receivable in the recess, which is formed on an inner surface of the clamp segment, the inner surface facing the pipe when the fastening device is mounted on the pipe, the recess preferably extending circumferentially along at least a section of the clamp segment, to attach the thermal insulating element to the clamp segment.

The fastening device may include a plurality of protrusions which may be provided on the thermal insulating element and/or on the clamping segment and which may be configured to engage with one or more recesses which may be provided on the thermal insulating element and/or one or more clamping segments. For instance, the protrusions and/or the recesses may be distributed on the thermal insulating element and/or on the clamping segment, respectively. For instance, at least two elongate recesses and at least two elongate protrusions may be provided, the recesses extending substantially parallel to each and the protrusions extending substantially parallel to each.

The protrusion(s) may be shaped as a dot or knob configured to be at least partially received in a respective recess.

Preferably, the protrusion is configured as a lip which extends along at least a section of the inner surface of the clamp segment, and the recess is configured as a groove which extends circumferentially along at least a section of the outer surface of the thermal insulating element. Preferably, the lip is configured to engage with the groove to attach the thermal insulating element to the clamp segment.

Preferably, the thermal insulating element is made of a thermally insulating foam, preferably polyolefin or a similar material. Further thermally insulating materials, in particular thermally insulating foam materials, which are suitable for decreasing the thermal transmittance of the fastening device may also be used.

Preferably, the clamping device has a locking device which is configured to lock the clamp segments in a mounted state on the pipe, preferably in a releasable manner such that the locking device may be unlocked. This may allow the clamping device to be maintained in the mounted or clamped state on the pipe. The clamping device may be unmounted from the pipe on demand by releasing or unlocking the locking device, e.g., for replacement purposes and/or servicing purposes and/or inspection purposes.

Preferably, the locking device includes a first engaging section provided on a first clamp segment of the at least two clamp segments and a second engaging section provided on a second clamp segment of the at least two clamp segments. Preferably, the first engaging section is engageable with the second engaging section, preferably as a snap-fit connection, to lock the clamp segments in a mounted state on the pipe. Preferably, at least one of the engaging sections is configured to be deflected as the engaging sections engage with each other.

Preferably, the locking device includes an unlock actuating member, e.g. provided on at least one of the clamp segments, and configured to be actuated by a user to unlock the locking device. Preferably, the unlock actuating member protrudes outwardly from an outer surface of the clamp segment and/or away from the pipe, when the fastening device is mounted on the pipe. This may enable the user to unlock the locking device on demand, e.g., in order to remove the clamp device from the pipe. This may also allow the user to single-handedly operate, e.g., release, the locking device which may facilitate installation and/or deinstallation of the fastening device.

Preferably, the unlock actuating member is configured to unlock the locking device by deflecting the unlock actuating member outwardly away from the outer surface of the clamp segment and/or away from the pipe, when the fastening device is mounted on the pipe, by a user.

Preferably, the pipe extends substantially vertically, i.e., substantially along the direction of gravity, when the pipe is fastened to the support structure by the fastening device. During installation of the fastening device on the pipe which extends substantially vertically, the thermal insulating element may remain attached to the clamping device due to the fixed attachment of the thermal insulating element to at least one of the clamp segments. If the fixed attachment of the thermal insulating element to at least one of the clamp segments were not provided and if the user does not manually hold the thermal insulating element in place, a risk of the thermal insulating element falling off of the clamping device would be relatively high due to the vertically extending pipe and the resulting and/or required orientation of the fastening device to secure the vertically extending pipe. Thus, the user does not have to hold the thermal insulating element in position in or on the clamping device due to the fixed attachment of the thermal insulating element to at least one of the clamp segments. This may enable the user to focus on clamping the clamping device onto the pipe and/or may enable the user to single-handedly operate, i.e., attach, the fastening device, which may allow the user to utilize the other arm/hand for other purposes, e.g., to support the user's body, e.g., the user's balance and/or body weight, during mounting and/or unmounting of the fastening device. Alternatively, the pipe may extend horizontally, i.e., substantially perpendicularly to the direction of gravity. Alternatively, the pipe may extend at an angle between a horizontal and a vertical orientation of the pipe.

Preferably, the fastening device includes a plurality of thermal insulating elements, which are preferably separate and/or detached from each other. Preferably, a first thermal insulating element of the plurality of thermal insulating elements is fixedly attached to a first clamp segment of the at least two clamp segments and a second thermal insulating element of the plurality of thermal insulating elements is fixedly attached to a second clamp segment of the at least two clamp segments.

Preferably, the thermal insulating elements may each have a semi-annular shape, i.e., the thermal insulating elements may each be configured as a ring segment. Preferably, the ring segments may be assembled to essentially form a full ring, preferably about the pipe. Preferably, a plurality of thermal insulating elements may each be configured as a ring segment, wherein at least two of the ring segments may have different degrees of circumferential extension.

Preferably, the clamp segments are connected to each other at a clamp interface where an opening of the clamp segments is not hindered by the thermal insulating element. For instance, a gap or seam between two adjacent thermal insulating elements, preferably shaped as ring segments, may be provided at the clamp interface. Preferably, the fastening device includes a plurality of thermal insulating elements, wherein at least two of the plurality of thermal insulating elements are adjoined and/or adjacent to each other at a thermal insulating interface which is aligned with the clamp interface(s). This may facilitate opening and/or closing of the clamping device with the thermal insulating elements attached thereon.

Preferably, at least one of the clamping segments includes a hollow space defined in at least a portion thereof. The hollow space may further reduce the thermal transmissivity and/or the weight of the fastening device. Preferably, a plurality of ribs extend through the hollow space to reinforce the clamping segment. This may provide the clamping segment with a higher robustness, e.g., to enable the clamping segment to absorb and/or withstand forces, such as compression forces, without compromising the structural integrity of the clamping segment.

Preferably, the attachment device includes an engaging element which is configured as a plate-like element, the plate-like element preferably having a first edge with a first spatial extension in a first direction and a second edge with a second spatial extension in a second direction. Preferably, the first spatial extension is greater than the second spatial extension, and preferably the first direction is substantially perpendicular to the second direction. This may facilitate the mounting and/or unmounting process of the attachment device on or in the support structure, e.g., by positioning and/or orientating the first edge and the second edge accordingly, e.g., manually by the user, e.g., by leading with the second edge through the support structure, during the mounting and/or unmounting process to enable and/or facilitate the mounting and/or unmounting process. The plate-like element may be substantially shaped as a parallelogram. This may increase a degree of extension of the plate-like element along the support structure and/or may increase a degree of support provided by the support structure to the plate-like element and/or may increase the stability of the connection between the attachment device and the support structure.

Preferably, the attachment device is configured to be inserted into a channel of a support structure which is configured as a rail or rail-like structure or strut. This may further facilitate the mounting and/or unmounting of the fastening device on the support structure. Moreover, this may allow the user to adjust a position and/or an orientation of the fastening device by displacing the fastening device, and thus displacing the attachment device within the channel of the support structure. This may also allow a plurality of fastening devices to be installed, preferably in a row and/or in a matrix, on the support structure, e.g., by successively inserting the attachment device of the respective fastening device into the channel of the support structure and sliding the attachment device of the respective fastening device in the channel to allow the attachment device of the subsequent fastening device to be inserted into the channel.

Preferably, the attachment device is configured to engage with and/or be inserted into a support structure in a first orientation, preferably a first rotational position. Preferably, the attachment device, in particular the engagement element thereof, is slidable in the support structure in said first rotational position. Preferably, the attachment device is configured to be substantially locked in place on the support structure in a second orientation, preferably a second rotational position, the first orientation being different from the second orientation. Preferably, the first and second orientations are rotational positions which are offset by at least 20°, more preferably at least 30° or at least 45° from each other, e.g. at substantially 90° from each other. This may allow the attachment device to be substantially locked in place in a relatively easy and/or intuitive manner, i.e., by rotating the attachment device into the second orientation.

The attachment device may be configured to be rotated about an axis that is oblique or substantially perpendicular to the pipe from the first to the second orientation. Preferably, the plate-like element is configured to be rotated about an axis that is oblique or substantially perpendicular to the pipe from the first to the second orientation. The attachment device may be configured to be rotated together with the plate-like element.

Preferably, the attachment device is configured to be rotated from the first orientation to the second orientation by rotating at least one of the clamp segments. Preferably, the entire fastening device is configured to be rotated to bring the attachment device from the first orientation to the second orientation to lock the attachment device in place on the support structure.

Preferably, the attachment device has at least one locking portion which is configured to engage with at least one counter-element provided on or in the support structure to lock the attachment device in place on the support structure. Preferably, the locking portion and the counter-element are configured as a snap-fit connection.

The counter-element may be a lip provided inside a channel provided in the support structure. The lip may be provided on a surface of the channel facing away from the clamp segments and/or facing towards the attachment device. The locking portion may be biased against a return force in order to engage with the counter-element, preferably biased away from the clamping device. The locking portion may be a deflectable portion that is deflected from an unbiased state as it engages with the lip. The locking portion may comprise a protrusion that protrudes from a first major surface of the attachment device, in particular a first major surface facing towards the clamping device.

Preferably, the attachment device is configured to be rotated by 10° to 120°, preferably by 20° to 110°, more preferably by 30° to 100°, more preferably by 40° to 100°, more preferably by 50° to 100°, most preferably by 600 to 100°, to rotate the attachment device between a first orientation and a second orientation to lock the attachment device in place on the support structure.

Preferably, a first end of the fastening device is provided with the attachment device and a second end of the fastening device, the second end preferably being substantially opposite of the first end, is free of an attachment device. This may allow the fastening device to be secured, preferably slidably secured, to the support structure at one end of the fastening device via the attachment device, i.e., at the first end of the fastening device. In this secured state, the user may position and/or align the fastening device and/or may mount the clamping device to the pipe. Optionally, the second end of the fastening device may be secured by abutting a support structure, i.e., the same support structure to which the attachment device arranged at the first end of the fastening device is attached or a further support structure, to the second end, preferably wherein the support structure is configured to apply a force, preferably a compression force, to the second end. For this purpose, the second end may be provided with one or more structural features which may facilitate such an abutment and/or compression at the second end, e.g., one or more protrusions and/or one or more recesses and/or one or more stiffened sections may be provided at the second end.

Preferably, the attachment device is configured to fasten the fastening device to a first support structure and the second end of the fastening device is configured to abut against a surface of a second support structure, e.g. a second rail.

Preferably, the fastening device is configured to be fastened between a first support structure and a second support structure. Preferably, the fastening device is configured to absorb a compressing force which can act between the first support structure and the second support structure. This may provide a clamping effect on the fastening device, e.g., to secure the fastening device between the first support structure and the second support structure. This may also increase the clamping effect on the pipe via the clamping device which may increase a fixation of the pipe by the fastening device.

Preferably, when the fastening device is mounted on the pipe, a first clamp segment of the plurality of clamp segments extends about a first section of the circumference of the pipe and a second clamp segment of the plurality of clamp segments extends about a second section of the circumference of the pipe.

Preferably, the second section is greater than the first section. Preferably greater by 10° to 120°, more preferably by 10° to 110°, more preferably by 20° to 110°, more preferably by 30° to 110°.

Alternatively or additionally, the second section and/or the insulating material retained in said section may extend over more than half the circumference of the pipe.

This may allow the fastening device to be pre-mounted to the pipe via the second clamp segment by placing the second clamp segment over the second section of the circumference of the pipe which may provide enough clamping force on the pipe such that the fastening device is held in place on the pipe and/or the pipe is held in place by the fastening device. In this pre-mounted or pre-secured state, the user may position and/or align the fastening device and/or may complete the process of mounting the clamping device to the pipe. This may further facilitate the installation and/or the securing of the pipe(s).

Preferably, the fastening device further includes a supplementary attachment device configured to attach at least one additional pipe to the fastening device. This may increase a range of functions of the fastening device by providing an attachment mechanism for said additional pipe to be attached to the fastening device. The additional pipe may be configured to transport one or more media therethrough, the one or more media being the same or different than the medium/media being transported by the pipe onto which the clamping device may be clamped. Preferably, the supplementary attachment device may be used for auxiliary pipes, such as a liquid line in which a refrigerant, e.g., in liquid phase, such as for direct expansion refrigeration, may be transported. This may allow one or more further attachment devices, which may be required to secure the additional pipe, to be omitted which may simplify the installation overall.

Preferably, the supplementary attachment device is configured to fixedly receive at least a portion of the additional pipe. The supplementary attachment device may be configured to fixedly receive and secure the additional pipe by means of at least one frictional connection (such as by clamping) and/or at least one form fit connection, such as an interference fit, and/or at least one material bond connection, such as an adhesive connection by means of at least one adhesive material. The supplementary attachment device may be configured to fix the pipe or at least a section of the pipe, onto which the clamping device may be clamped, and the additional pipe relative to each other.

Preferably, the supplementary attachment device is configured such that the pipe, on which the clamping device is mountable, and the additional pipe, to which the supplementary attachment device is attachable, extend substantially parallel to each other, when the clamping device is mounted on the pipe and the supplementary attachment device is attached to the additional pipe. This may allow the medium being transported in the pipe, on which the clamping device is mountable, and the medium being transported in the additional pipe, to which the supplementary attachment device is attachable, to be transported in substantially the same direction. This may be useful when both media are to be transported to the same location or at least in substantially the same direction.

Preferably, the supplementary attachment device is configured such that at least a section of the supplementary attachment device is deflectable as the additional pipe is received at least partially by the supplementary attachment device. The supplementary attachment device may be configured such that the deflectable section of the supplementary attachment device provides a force on the additional pipe, when the additional pipe is received in the supplementary attachment device, to secure the additional pipe at least partially in the supplementary attachment device.

Preferably, the clamp segments and/or the attachment device is/are made at least partially of a plastic material.

Preferably, the clamp segments and/or the attachment device is/are made at least partially of a composite material.

Preferably, the fastening device further includes a fixating device which is arranged on an outer surface of at least one of the clamp segments, the outer surface preferably facing away from the pipe and/or the thermal insulating element, when the fastening device is mounted on the pipe. Preferably, the fixating device has at least one opening configured to receive an external element, preferably an elongate external element, therein. For instance, the external element may be attached to the fixating device by means of a tie wrap or a wire, e.g., by inserting the tie wrap or the wire and looping the tie wrap or the wire at least partially around the fixating device and the external element.

Preferably, the fixating device is formed integrally and/or monolithically with the clamping segment. Preferably, the fixating device includes at least two protrusions which each extend from the outer surface of the clamp segment and one connecting segment which connects the protrusions. Preferably, the opening is at least partially defined by the protrusions, the connecting segment and the outer surface of the clamp segment.

Preferably, the fixating device includes at least two openings which are arranged substantially adjacent to each other.

Preferably, the opening(s) extend(s) between the protrusions, the connecting segment and the outer surface of the clamp segment in a direction which is substantially parallel to a longitudinal axis of the pipe, on which the fastening device is mountable.

Preferably, the thermal insulating material of the thermal insulating element has a thermal conductivity which is less than a thermal conductivity of a material of the clamp segments. Preferably, the thermal insulating material has a thermal conductivity of 0.5 W/mK or less, more preferably 0.4 W/mK or less, more preferably 0.3 W/mK or less, more preferably 0.2 W/mK or less, more preferably 0.1 W/mK or less, more preferably 0.09 W/mK or less, more preferably 0.08 W/mK or less, more preferably 0.07 W/mK or less, most preferably 0.06 W/mK or less.

Preferably, the fastening device further includes at least one indicating device configured to indicate, preferably visually, a degree of fixture of the fastening device to the support structure which is provided by the fastening device. This may provide an indication to the user that a certain degree of fixture, preferably a predetermined or target degree of fixture, of the fastening device to the support structure has been achieved. Thus, this may give an indication to the user that the mounting process of the fastening device may be terminated. This may allow a minimum degree of fixture and/or a maximum degree of fixture of the fastening device to be achieved relatively accurately and/or reliably. Moreover, this may prevent, or at least reduce the risk of, oversecuring by overloading, e.g., overtightening and/or overcompressing, the fastening device which may compromise the structural integrity of the fastening device. Preferably, the degree of fixture is a level of a force, preferably a compressing force, provided to the pipe by the fastening device and/or to the fastening device by the support structure.

Preferably, the attachment device and the clamping device are fixed to each other at least in a non-rotatable manner. Preferably, the attachment device and the clamping device are integrally formed. This may allow the attachment device and the clamping device, to be moved, i.e., translationally and/or rotatably, as a unit. This may facilitate the mounting and/or unmounting of the fastening device. For instance, the user may grasp the clamping device and manoeuvre the clamping device in order to attach the attachment device to the support structure without the risk of displacing the attachment device relative to the clamping device.

The object discussed at the beginning is also achieved by a system for fixating at least one pipe which is defined by the features of independent claim 13. Preferred embodiments are defined by the features of the respective dependent claims. The configurations and advantages as detailed above with respect to the fastening device apply accordingly to the system.

The system may include a support structure, preferably a rail or rail-like structure or strut, and a fastening device for fastening the pipe to the support structure according to any of the embodiments described herein.

Preferably, the system includes a plurality of fastening devices for fastening a plurality of pipes or a plurality of sections of a pipe to the support structure. Preferably, each fastening device is configured to fasten a separate pipe or a separate pipe section to the support structure.

Preferably, the fastening devices are arranged serially in at least one row. Preferably, at least two of the fastening devices each fasten a separate pipe or a separate pipe section to the same support structure.

Preferably, the fastening device(s) is/are compressed by a compressing force which acts between the support structure and an end of the fastening device(s), the end preferably being arranged opposite from the support structure.

Preferably, the system includes at least two support structures. The support structures may be arranged on opposite ends of the fastening device(s). Preferably, a compressing force acts between the support structures, e.g., on the plurality of fastening devices. This may allow the fastening device(s) to be mounted, preferably clamped, between the support structures.

Preferably, the system includes a compressing force generating device which is configured to engage with and exert a compressing force between the at least two support structures, or engage with one support structure and the fastening device and exert a compressing force therebetween.

Preferably, the system is configured such that the compressing force acts substantially perpendicular to a longitudinal axis of the pipe, when the fastening device is mounted on the pipe. The compressing force may enhance a clamping effect of the clamping device on the respective pipe.

The following list of aspects provides preferred embodiments of the present disclosure:
1. A fastening device for fastening at least one pipe to at least one support structure, including:
   at least one securing device, preferably a clamping device, having at least two segments, preferably at least two clamp segments, which are movably, preferably rotatably, connected to each other such that the securing device is mountable and unmountable on at least a portion of a circumference of the pipe by moving, preferably rotating, the segments relative to each other, preferably about a rotation axis, preferably about a clamping device rotation axis;
   at least one insulating element, preferably at least one thermal insulating element made of a thermal insulating material configured to decrease a thermal transmittance of the fastening device, wherein the insulating element is at least partially arranged between at least one of the segments, preferably clamp segments, and at least a section of the pipe, when the fastening device is mounted to the pipe, and wherein the insulating element is fixedly attached to at least one of the segments, preferably clamp segments; and
   optionally, at least one attachment device configured to fixedly attach the fastening device to the support structure.
2. The fastening device according to aspect 1, wherein at least one of the clamp segments has an attachment section, the attachment section being configured to engage with at least a section of the thermal insulating element to fixedly attach the thermal insulating element to the clamp segment, preferably wherein the attachment section is integrally formed on the clamp segment.
3. The fastening device according to aspect 2, wherein the attachment section includes at least one protrusion which protrudes from an inner surface of the clamp segment, the inner surface facing the pipe when the fastening device is mounted on the pipe, the protrusion preferably being elongate in a direction along at least a section of the inner surface, the protrusion being configured to engage with a recess which is formed in at least a section of an outer surface of the thermal insulating element which faces the inner surface of the clamp segment, when the fastening device is mounted on the pipe, the recess preferably extending circumferentially along at least a section of the thermal insulating element, to fixedly attach the thermal insulating element to the clamp segment.
4. The fastening device according to aspect 3, wherein the protrusion is configured as a lip which extends along at least a section of the inner surface of the clamp segment, and the recess is configured as a groove which extends circumferentially along at least a section of the outer surface of the thermal insulating element, wherein the lip is configured to engage with the groove to fixedly attach the thermal insulating element to the clamp segment.
5. The fastening device according to any of the preceding aspects, wherein the thermal insulating element is made of a thermally insulating foam. Alternatively, the thermal insulating element may be made of any other material, e.g., any material which is suitable for providing thermally insulating properties.
6. The fastening device according to any of the preceding aspects, wherein the clamping device has a locking device which is configured to lock the clamp segments in a mounted state on the pipe, preferably in a releasable manner such that the locking device may be unlocked.
7. The fastening device according to aspect 6, wherein the locking device includes a first engaging section provided on a first clamp segment of the at least two clamp segments and a second engaging section provided on a second clamp segment of the at least two clamp segments, wherein the first engaging section is engageable with the second engaging section, preferably as a snap-fit connection, to lock the clamp segments in a mounted state on the pipe.
8. The fastening device according to aspect 7, wherein at least one of the engaging sections is configured to be deflected as the engaging sections engage with each other.
9. The fastening device according to aspect 7 or 8, wherein the locking device includes an unlock actuating member provided on at least one of the clamp segments and configured to be actuated by a user to unlock the locking device, wherein the unlock actuating member protrudes outwardly from an outer surface of the clamp segment and/or away from the pipe, when the fastening device is mounted on the pipe.
10. The fastening device according to aspect 9, wherein the unlock actuating member is configured to unlock the locking device by deflecting the unlock actuating member outwardly away from the outer surface of the clamp segment and/or away from the pipe, when the fastening device is mounted on the pipe, by a user.
11. The fastening device according to any of the preceding aspects, wherein the clamp segments are rotatably connected to each other via at least one hinge, which is preferably integrated at least partially in at least one of the clamp segments.
12. The fastening device according to any of the preceding aspects, wherein the pipe extends substantially vertically, when the pipe is fastened to the support structure by the fastening device.
13. The fastening device according to any of the preceding aspects, including a plurality of thermal insulating elements, which are preferably detached from each other, wherein a first thermal insulating element of the plurality of thermal insulating elements is fixedly attached to a first clamp segment of the at least two clamp segments and a second thermal insulating element of the plurality of thermal insulating elements is fixedly attached to a second clamp segment of the at least two clamp segments.
14. The fastening device according to any of the preceding aspects, wherein at least one of the clamping segments includes a hollow space defined in at least a portion thereof, wherein a plurality of ribs extend through the hollow space to reinforce the clamping segment.
15. The fastening device according to any of the preceding aspects, wherein the attachment device includes an engaging element which is configured as a plate-like element, the plate-like element preferably having a first edge with a first spatial extension in a first direction and a second edge with a second spatial extension in a second direction, wherein the first spatial extension is greater than the second spatial extension, and preferably wherein the first direction is substantially perpendicular to the second direction.
16. The fastening device according to any of the preceding aspects, wherein the attachment device is configured to be inserted into a channel of a support structure which is configured as a rail or rail-like structure or strut.
17. The fastening device according to any of the preceding aspects, wherein the attachment device is configured to engage with and/or be inserted into a support structure in a first orientation, preferably a first rotational position, and wherein the attachment device is configured to be substantially locked in place on the support structure in a second orientation, preferably a second rotational position, the first orientation being different from the second orientation, wherein preferably the first and second orientations are rotational positions which are offset by substantially 90° to each other.
18. The fastening device according to aspect 17, wherein the attachment device is configured to be rotated from the first orientation to the second orientation by rotating at least one of the clamp segments, preferably wherein the entire fastening device is configured to be rotated to bring the attachment device from the first orientation to the second orientation to lock the attachment device in place on the support structure.
19. The fastening device according to any of the preceding aspects, wherein the attachment device has at least one locking portion which is configured to engage with at least one counter-element provided on or in the support structure to lock the attachment device in place on the support structure, wherein preferably the locking portion and the counter-element form a snap-fit connection.
20. The fastening device according to any of the preceding aspects, wherein the attachment device is configured to be rotated by 10° to 120°, preferably by 20° to 110°, more preferably by 30° to 100°, more preferably by 400 to 100°, more preferably by 50° to 100°, most preferably by 600 to 100°, to rotate the attachment device between a first orientation and a second orientation to lock the attachment device in place on the support structure.
21. The fastening device according to any of the preceding aspects, wherein a first end of the fastening device is provided with the attachment device and a second end of the fastening device, the second end preferably being substantially opposite of the first end, is free of an attachment device.
22. The fastening device according to aspect 21, wherein the attachment device is configured to fasten the fastening device to a first support structure and the second end of the fastening device is configured to abut against a surface of a second support structure.
23. The fastening device according to any of the preceding aspects, wherein the fastening device is configured to be fastened between a first support structure and a second support structure, wherein the fastening device is configured to absorb a compressing force which can act between the first support surface and the second support surface.
24. The fastening device according to any of the preceding aspects, wherein, when the fastening device is mounted on the pipe, a first clamp segment of the plurality of clamp segments extends about a first section of the circumference of the pipe and a second clamp segment of the plurality of clamp segments extends about a second section of the circumference of the pipe, the second section being greater than the first section.
25. The fastening device according to any of the preceding aspects, further including a supplementary attachment device configured to attach at least one additional pipe to the fastening device.
26. The fastening device according to aspect 25, wherein the supplementary attachment device is configured to fixedly receive at least a portion of the additional pipe.
27. The fastening device according to aspect 25 or 26, wherein the supplementary attachment device is configured such that the pipe, on which the clamping device is mountable, and the additional pipe, to which the supplementary attachment device is attachable, extend substantially parallel to each other, when the clamping device is mounted on the pipe and the supplementary attachment device is attached to the additional pipe.
28. The fastening device according to any of aspects 25 to 27, wherein the supplementary attachment device is configured such that at least a section of the supplementary attachment device is deflectable as the additional pipe is received at least partially by the supplementary attachment device.
29. The fastening device according to any of the preceding aspects, wherein the clamp segments and/or the attachment device is/are made at least partially of a plastic material.
30. The fastening device according to any of the preceding aspects, wherein the clamp segments and/or the attachment device is/are made at least partially of a composite material. Alternatively, the clamp segments and/or the attachment device may be made of any other material.
31. The fastening device according to any of the preceding aspects, further including a fixating device which is arranged on an outer surface of at least one of the clamp segments, the outer surface preferably facing away from the pipe and/or the thermal insulating element, when the fastening device is mounted on the pipe, wherein the fixating device has at least one opening configured to receive an external element, preferably an elongate external element, therein.
32. The fastening device according to aspect 31, wherein the fixating device is formed integrally and/or monolithically with the clamping segment, wherein the fixating device includes at least two protrusions which each extend from the outer surface of the clamp segment and one connecting segment which connects the protrusions, wherein the opening is at least partially defined by the protrusions, the connecting segment and the outer surface of the clamp segment.
33. The fastening device according to aspect 31 or 32, wherein the fixating device includes at least two openings which are arranged substantially adjacent to each other.
34. The fastening device according to aspect 32 or 33, wherein the opening(s) extend(s) between the protrusions, the connecting segment and the outer surface of the clamp segment in a direction which is substantially parallel to a longitudinal axis of the pipe, on which the fastening device is mountable.
35. The fastening device according to any of the preceding aspects, wherein the thermal insulating material of the thermal insulating element has a thermal conductivity which is less than a thermal conductivity of a material of the clamp segments.
36. The fastening device according to any of the preceding aspects, further including at least one indicating device configured to indicate, preferably visually, a degree of fixture of the pipe to the support structure which is provided by the fastening device, preferably wherein the degree of fixture is a level of a force, preferably a compressing force, provided to the pipe by the fastening device and/or the support structure.
37. The fastening device according to any of the preceding aspects, wherein the attachment device and the clamping device are fixed to each other at least in a non-rotatable manner, preferably wherein the attachment device and the clamping device are integrally formed.
38. A system for fixating at least one pipe, including a support structure, preferably a rail or rail-like structure or strut, and a fastening device according to any of the preceding aspects for fastening the pipe to the support structure.
39. The system according to aspect 38, including a plurality of fastening devices for fastening a plurality of pipes or a plurality of sections of a pipe to the support structure, wherein each fastening device is configured to fasten a separate pipe or a separate pipe section to the support structure.
40. The system according to aspect 39, wherein the fastening devices are arranged serially in at least one row, wherein preferably at least two of the fastening devices each fasten a separate pipe or a separate pipe section to the same support structure.
41. The system according to any of aspects 38 to 40, wherein the fastening device(s) is/are compressed by a compressing force which acts between the support structure and an end of the fastening device(s), the end preferably being arranged opposite from the support structure.
42. The system according to any of aspects 38 to 41, including at least two support structures, the support structures preferably being arranged on opposite ends of the fastening device(s), wherein preferably a compressing force acts between the support structures.
43. The system according to any of aspects 38 to 42, including a compressing force generating device which is configured to:
engage with and exert a compressing force between the at least two support structures; or
engage with one support structure and the fastening device and exert a compressing force therebetween.
44. The system according to any of aspects 41 to 43, wherein the system is configured such that the compressing force acts substantially perpendicular to a longitudinal axis of the pipe, when the fastening device is mounted on the pipe.

Embodiments of the present disclosure are further elucidated below with reference to the figures. The figures are schematic drawings and as such may not show all details of the systems and their components. Particularly, the drawings are not necessarily to scale, and the shown dimensions are only exemplary and may vary. The drawings illustrate exemplary embodiments to provide a thorough understanding of the present disclosure. The drawings are not intended to limit the scope of the invention, which is defined by the appended claims and is to include the equivalents thereof.

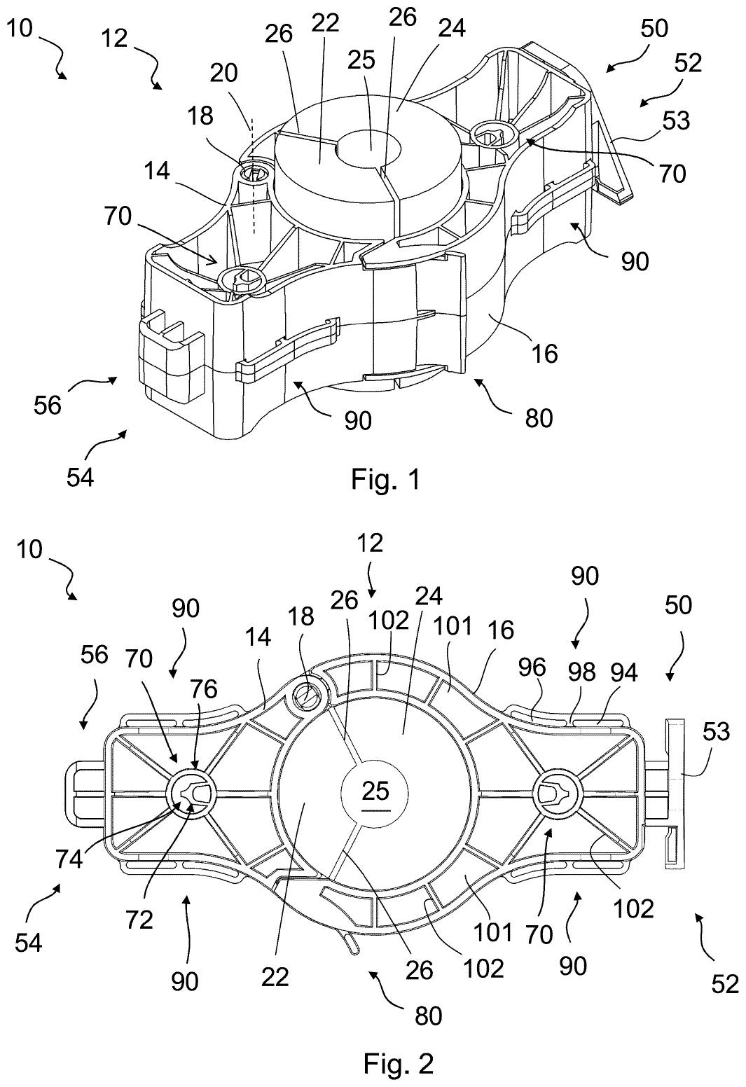

FIG. 1 shows a schematic perspective view of a fastening device according to a first embodiment, wherein a clamping device of the fastening device is in a closed state;

FIG. 2 shows a schematic top view of the fastening device of FIG. 1;

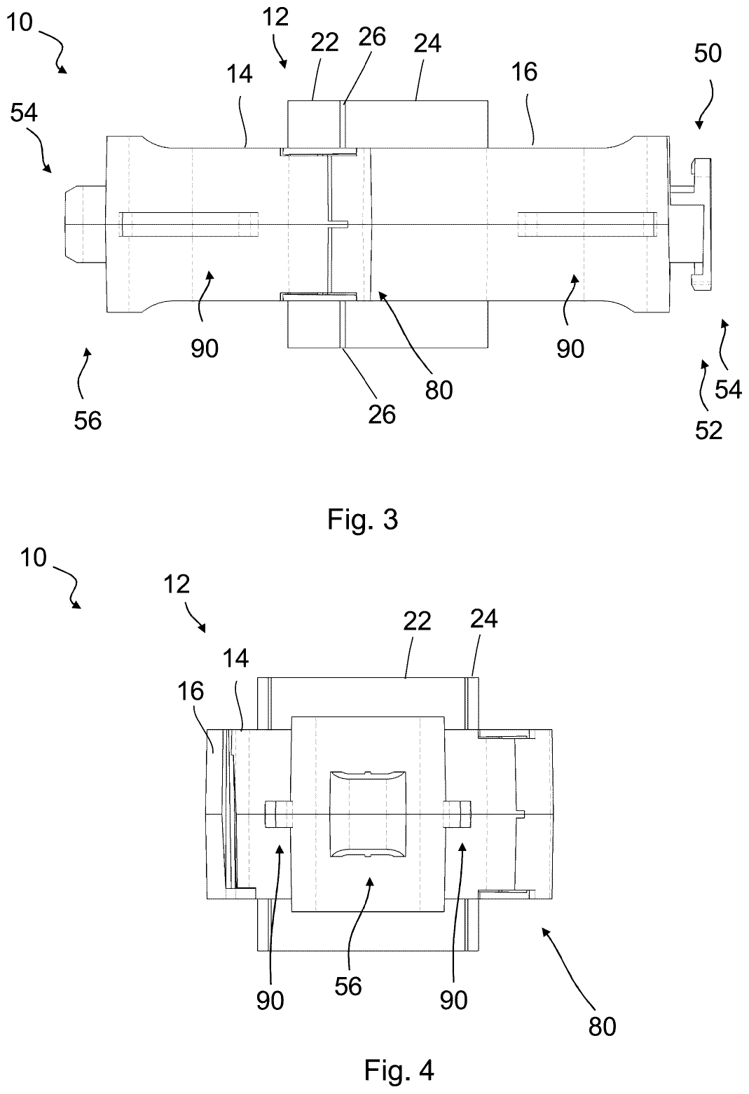

FIG. 3 shows a schematic side view of the fastening device of FIG. 1;

FIG. 4 shows a further schematic side view of the fastening device of FIG. 1;

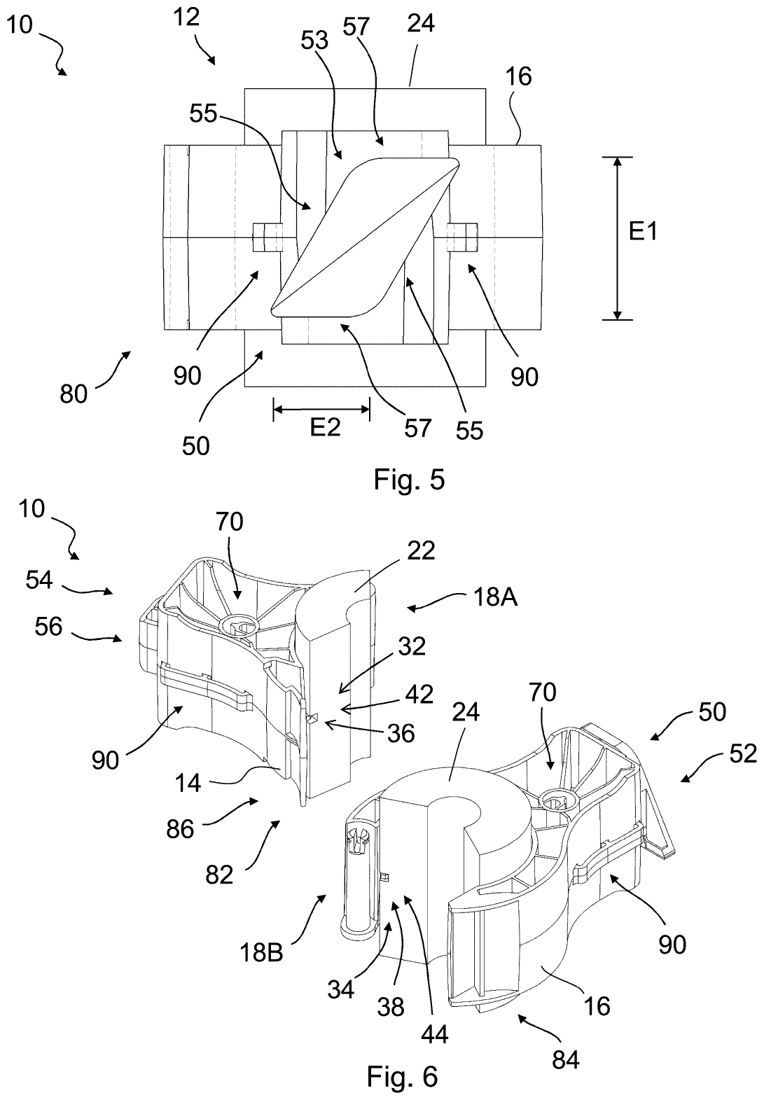

FIG. 5 shows a further schematic side view of the fastening device of FIG. 1;

FIG. 6 shows a schematic exploded view of the fastening device of FIG. 1;

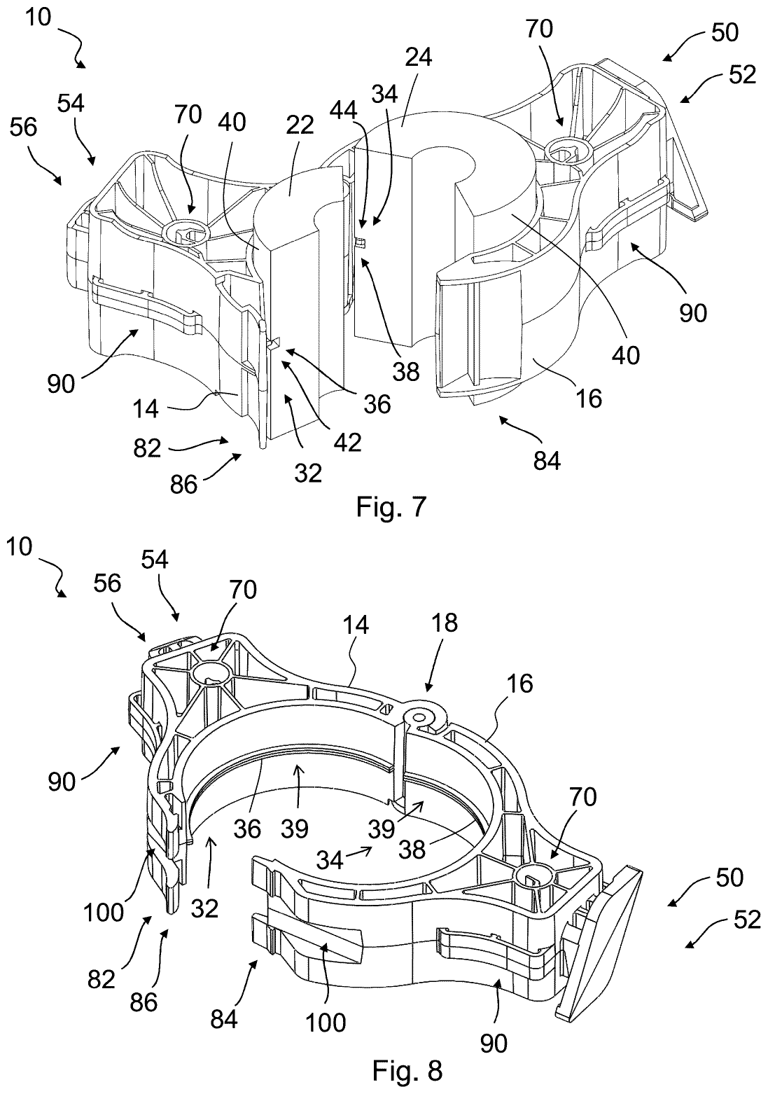

FIG. 7 shows a schematic perspective view of the fastening device of FIG. 1, wherein the clamping device is in an open state;

FIG. 8 shows the view of FIG. 7 of the fastening device, wherein the first thermal insulating elements have been omitted from FIG. 8 for illustrative purposes;

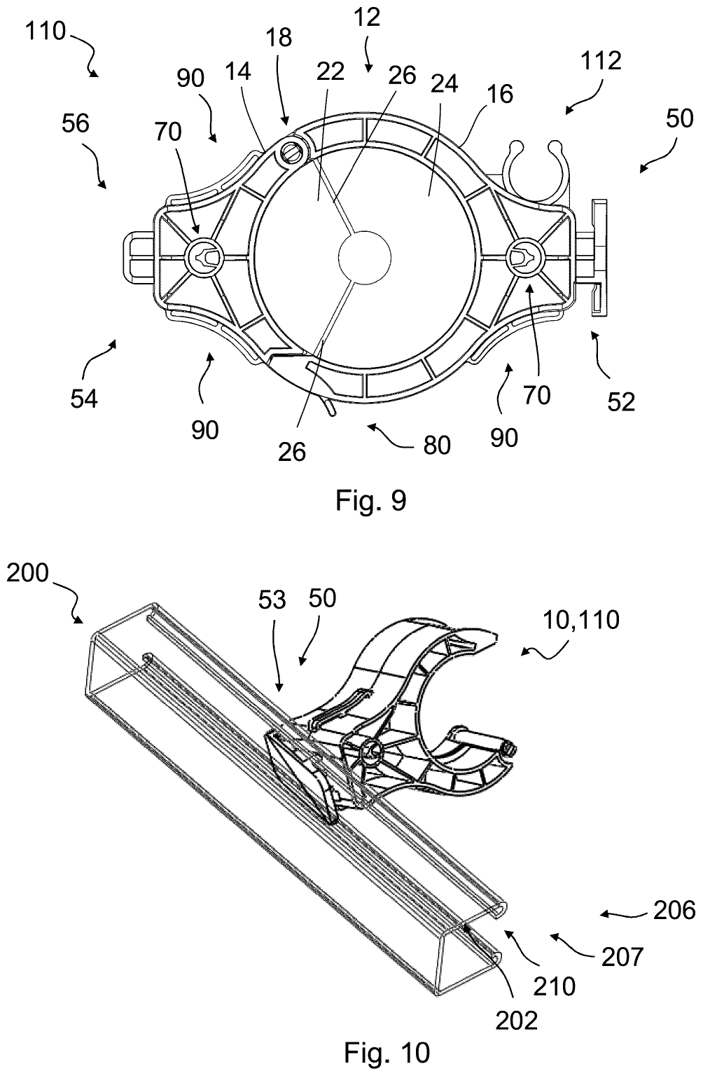

FIG. 9 shows a schematic top view of a fastening device according to a further embodiment;

FIG. 10 schematically shows a process for mounting the fastening device of any of FIGS. 1 to 9 to a support structure;

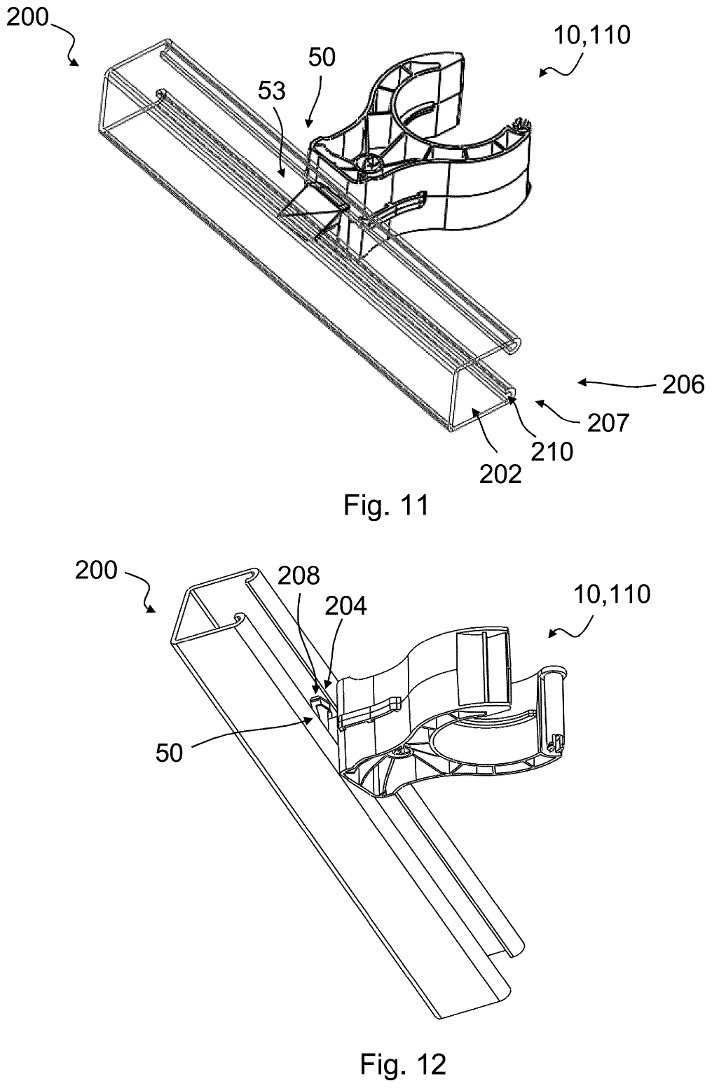

FIG. 11 schematically further shows a process for mounting the fastening device of any of FIGS. 1 to 9 to a support structure;

FIG. 12 schematically further shows a process for mounting the fastening device of any of FIGS. 1 to 9 to a support structure;

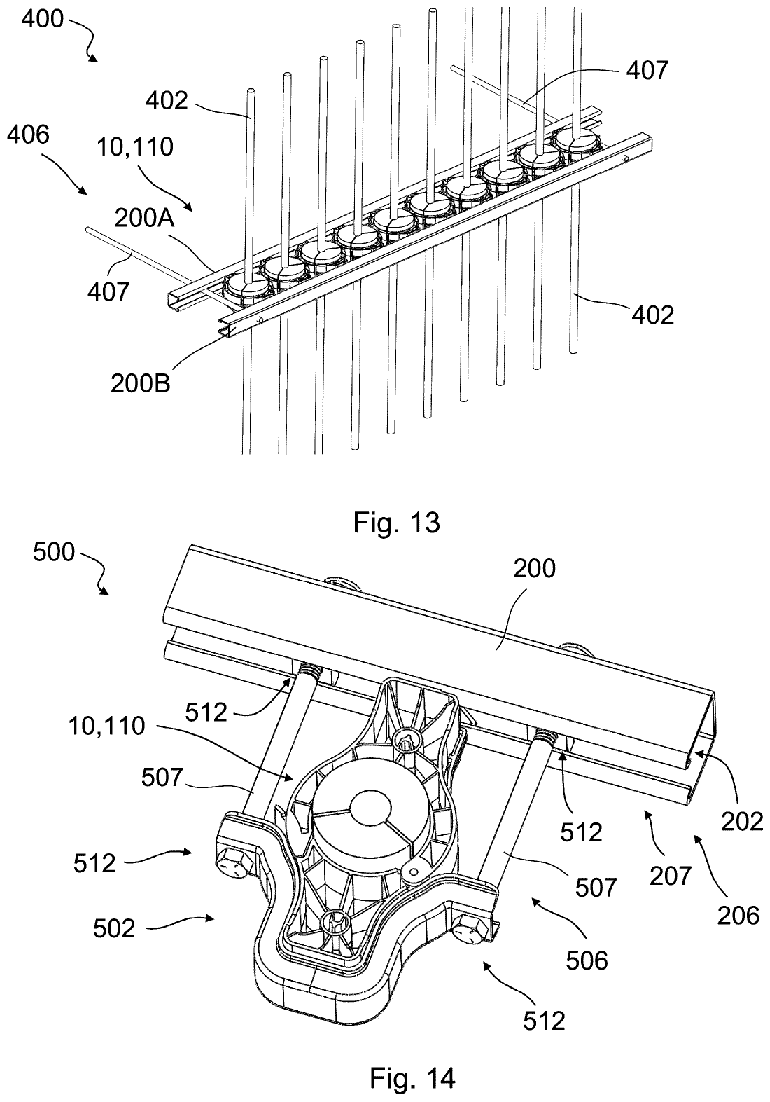

FIG. 13 schematically shows a system for fixating a plurality of pipes according to a first embodiment;

FIG. 14 schematically shows a system for fixating at least one pipe according to a further embodiment.

FIGS. 1 to 8 show a fastening device 10 for fastening at least one pipe to at least one support structure according to an embodiment of the present disclosure. The fastening device 10 includes a clamping device 12 which has a first clamp segment 14 and a second clamp segment 16 which are rotatably connected to each other at a hinge 18. The hinge 18, or at least a section thereof, may be formed integrally with at least one of the clamp segments 14, 16 as a coherent and/or monolithic unit. As best seen in FIG. 6, a first hinge section 18A of the hinge 18 is integrated in the first clamp segment 14 and a second hinge section 18B of the hinge 18 is integrated in the second clamp segment 16. The second hinge section 18B is at least partially receivable in the first hinge section 18A such that the second hinge section 18B may be rotatable within and relative to the first hinge section 18A to enable the clamp segments 14, 16 to be rotated relative to each other.

The clamping device 12 is mountable and unmountable on at least a portion of a circumference of the pipe by rotating the clamp segments 14, 16 relative to each other about a clamping device rotation axis 20 which extends through the hinge 18.

As can be seen in FIGS. 1 to 8, the clamp segments 14, 16 are not configured identically. In particular, the first clamp segment 14 is configured to extend about a first section of the circumference of the pipe and the second clamp segment 16 is configured to extend about a second section of the circumference of the pipe, the second section being greater than the first section. Hence, the second clamp segment 16 is configured to receive a larger proportion of the circumference of the pipe than the first clamp segment 14. Preferably, the second clamp segment 16 is configured to receive a large enough proportion of the circumference of the pipe such that the fastening device 10 may be pre-mounted to the pipe via the second clamp segment 16 by placing the second clamp segment 16 over the second section of the circumference of the pipe which may provide enough clamping force on the pipe such that the fastening device 10 is at least partially held in place on the pipe. In this pre-mounted or pre-secured state, the user may position and/or orientate and/or align the fastening device 10 and/or may complete the process of mounting the clamping device to the pipe. This may further facilitate the installation and/or the securing of the pipes.

The fastening device 10 further includes a first thermal insulating element 22 and a second thermal insulating element 24 which are both made of a thermal insulating material configured to decrease a thermal transmittance of the fastening device 10. The thermal insulating elements 22, 24 may be made of a thermally insulating material, such as a thermally insulating foam. The first thermal insulating element 22 is fixedly attached to the first clamp segment 14 and the second thermal insulating element 24 is fixedly attached to the second clamp segment 16.

The thermal insulating elements 22, 24 are arranged between the respective clamp segment 14, 16 to which the respective thermal insulating element 22, 24 is attached and at least a section of the pipe, when the fastening device 10 is mounted to the pipe. The thermal insulating elements 22, 24 provide an opening 25 through which the pipe may be inserted and/or extend.

The thermal insulating elements 22, 24 are shaped as ring segments. Moreover, the thermal insulating elements 22, 24 are detached from each other and/or provided as discrete elements. In particular, the thermal insulating elements 22, 24 may be configured to be separated and/or moved away from each other at one or more locations 26, which may be formed as gaps. Preferably, the thermal insulating elements 22, 24 are configured to be separated and/or moved away from each other at two locations 26, as shown.

Thus, the clamp segment 14 and the thermal insulating element 22 attached thereto and the clamp segment 16 and the thermal insulating element 24 attached thereto can respectively be rotated as coherent units independently from each other. In other words, the thermal insulating element 22 remains attached to the clamp segment 14 and the thermal insulating element 24 remains attached to the clamp segment 16 as the clamp segments 14, 16 are rotated with respect to each other about the clamping device rotation axis 20.

This may allow the thermal insulating elements 22, 24 to be securely pre-mounted to the respective clamp segment 14, 16. The thermal insulating elements 22, 24 are therefore securely held in place on the respective clamp segment 14, 16 during mounting and/or unmounting of the fastening device 10 on the pipe and/or on the support structure.

Each clamp segment 14, 16 includes an attachment section 32, 34 which is integrally formed on the clamp segment 14, 16 (see FIGS. 6 to 8). The attachment sections 32, 34 are configured to engage with at least a section of the thermal insulating element 22, 24 to fixedly attach the thermal insulating element 22, 24 to the respective clamp segment 14, 16.

Each attachment section 32, 34 includes a protrusion 36, 38 configured as a lip which extends along at least a section of an inner surface 39 of the respective clamp segment 14, 16. The protrusions 36, 38 are elongate in a direction along at least a section of the inner surface 39. Each protrusion 36, 38 is configured to engage with a recess 42, 44 which is formed in at least a section of an outer surface 40 of the respective thermal insulating element 22, 24 which faces the inner surface 39 of the clamp segment 14, 16, when the fastening device 10 is mounted on the pipe, to fixedly attach the thermal insulating element 22, 24 to the clamp segment 14, 16. The recesses 42, 44 extend circumferentially along at least a section of the thermal insulating element 22, 24. The recesses are configured as grooves in the embodiment shown in FIGS. 1 to 8.

The protrusions 36, 38 are best seen in FIG. 8, which shows the view of FIG. 7 of the fastening device. However, in contrast to FIG. 7, the first thermal insulating elements 22, 24 have been omitted from the view of FIG. 8 in order to more clearly show the protrusions 36, 38.

The fastening device 10 further includes an attachment device 50 configured to fixedly attach the fastening device 10 to the support structure. The attachment device 50 is shown in detail in FIG. 5.

As shown in FIGS. 1 to 8, the attachment device 50 is provided at a first end 52 of the fastening device 10. A second end 54 of the fastening device 50, which is substantially opposite of the first end 52, is free of an attachment device, or at least free of the same attachment device 50 as provided at the first end 52. The second end 54 of the fastening device 50 may be configured to abut an external structure, such as a support structure, e.g. via a plane surface. Preferably, the second end 54 is configured to receive and/or absorb a compressing force, e.g., via the support structure and/or a further external structure.

The second end 54 may be provided with an engaging portion 56, configured as a protrusion or pin, extending from an external surface of the fastening device 10 in FIGS. 1 to 8. The engaging portion 56 may be configured to be received in a whole or groove of a support structure that is pressed against the second end 54.

As shown in FIG. 5, the attachment device 50 includes an engaging element 53 which is configured as a plate-like element, the plate-like element 53 having a first edge 55 with a first spatial extension E1 in a first direction and a second edge 57 with a second spatial extension E2 in a second direction, wherein the first spatial extension E1 is greater than the second spatial extension E2 (see FIG. 5). As can be seen in FIG. 5, the first direction may be substantially perpendicular to the second direction. The first direction may be aligned with the longitudinal axis of the pipe and/or of the opening 25.

The attachment device 50 may be configured to be inserted into a channel of a support structure which is configured as a rail or rail-like structure or strut, as shown in FIGS. 10 to 14 and described in further detail with respect to said FIGS. 10 to 14 below.

As shown in FIGS. 1 to 8, the fastening device 10 further includes an indicating device 70 configured to indicate, at least visually, a degree of fixture of the fastening device 10 to the support structure and/or a degree of fixture of the pipe in the fastening device 10. Preferably, the degree of fixture is a level of a force, preferably a compressing force or a tensile force, provided to the support structure to the fastening device 10.

The indicating device 70 includes a projection 72 which is arranged within an opening 74 which is at least partially defined by an indicator wall 76 (see FIG. 2). At least in an unmounted state, the projection 72 may be spaced by a certain distance from the indicator wall 76. As the fastening device 10 is being fixed to the support structure, preferably via a compressing force and/or a tensile force, the distance between the projection 72 and the indicator wall 76 may be changed, e.g., reduced or increased. In other words, the projection 72 may be moved towards or away from the indicator wall 76 as the fastening device 10 is being fixed to the support structure. Thus, the distance between the projection 72 and the indicator wall 76 may provide an indication of a degree of fixture of the pipe to the support structure to the user. For instance, the indicating device 70 may provide an indication to the user to stop increasing the degree of fixture once the projection 72 touches the indicator wall 76.

The fastening device 10 further includes an a locking device 80 which is configured to releasably lock the clamp segments 14, 16 in a mounted state on the pipe such that the clamp segments 14, 16 may be locked in a mounted state on the pipe and unlocked to release the clamp segments 14, 16 from the mounted state. The locking device 80 includes a latch element 82 provided on the clamp segment 14 which is configured to be deflectable, when a force is exerted thereon (see FIGS. 6 to 8). The locking device 80 further includes an engagement element 84 configured to engage with the latch element 82 to connect and secure the clamp segments 14, 16 in a clamped or substantially closed state. As the first clamp segment 14 and/or the second clamp segment 16 is/are rotated towards the closed state, the engagement element 84 provides a resistance to the latch element 82. Since the latch element 82 is configured to be deflectable, the latch element 82 may be deflected from a starting position at least partially away from the engagement element 84 to a deflected position to circumvent or overcome the resistance provided by the engagement element 84. The latch element 82 may then return from the deflected position towards the starting position, e.g., to the starting position, and provide an interlock with the engagement element 84 to prevent the clamping segments 14, 16 from being rotated out of the closed or mounted state.

The locking device 80 includes an unlock actuating member 86 provided on the first clamp segment 14 and configured to be actuated by a user to unlock the locking device 80. Preferably, the unlock actuating member 86 may be configured to unlock the locking device 80 by being deflected away from the engagement element 84 to release the interlock between the engagement element 84 and the latch element 82. The unlock actuating member 86, e.g., protrudes outwardly from the clamp segment 14 and away from the pipe to allow the user to grasp the unlock actuating member 86 more easily. This may enable the user to unlock the locking device 80 on demand, e.g., in order to remove the clamp device 12 from the pipe. Preferably, the unlock actuating member 86 is single-handedly operable by the user to facilitate installation and/or deinstallation of the fastening device 10.

The fastening device 10 further includes fixating devices 90 which are arranged on an outer surface of each of the clamp segments 14, 16. The outer surface of the clamp segments 14, 16 faces away from the pipe and/or the thermal insulating elements 22, 24, when the fastening device 10 is mounted on the pipe. Each fixating device 90 has two openings 94, 96 which are separated by a separating wall 98, each opening 94, 96 being configured to receive an external element, preferably an elongate external element, such as a wire, cable tie or the like, therein. In particular, the fixating devices 90 may be configured to attach an external element thereto by looping a securing element, such as a wire or a cable tie, through the respective fixating devices 90 and securing the external element to the respective fixating devices 90 via the securing element.

As shown in FIGS. 1 to 8, the fixating devices 90 extend substantially in and/or along a plane which is substantially perpendicular to a longitudinal axis of the pipe and/or to the clamping device rotation axis 20, when the fastening device 10 is mounted on the pipe. Alternatively, the fixating devices 90 may be angled, e.g., inclined, with respect to a plane which is substantially perpendicular to a longitudinal axis of the pipe and/or to the clamping device rotation axis 20, preferably at an angle from 5° to 80° with respect to the plane, more preferably from 100 to 750, more preferably from 15° to 70°, more preferably from 20° to 65°, more preferably from 25° to 60°, most preferably from 30° to 55°. Configuring the fixating devices 90 to be angled as described above may prevent, or at least reduce the risk of, the securing element, e.g., a wire or cable tie, from twisting, in particular when a longitudinal axis of the external element extends substantially parallel to a longitudinal axis of the pipe, when the fastening device 10 is mounted on the pipe.

The fastening device 10 further includes indentations 100 (see FIG. 8) provided on an outer surface of the clamping device 12. The indentations 100 are configured as grooves formed in the outer surface of the clamping device 12. The indentations 100 may be configured to at least partially receive an external element, preferably an elongate external element, preferably a rod, preferably a threaded rod which may be configured to provide a compressive force on the fastening device 10. In particular, the indentations 100 may be configured to receive an element of a compressing force generating device configured to generate a compressive force on the fastening device 10, such as a rod thereof, as described in more detail below with respect to FIGS. 13 and 14. By enabling the external element to be received at least partially within the indentations 100, the effective width of the fastening device 10 including the external element may be reduced. This may reduce the space required for the pipe installation. In particular, when a plurality of fastening devices 10 are arranged in a row adjacent to each other, the packing density of the fastening devices 10 may be increased which may reduce the space required for the installation and/or may allow more fastening devices 10 and more pipes to be installed for a given installation space.

The fastening device 10, more specifically the clamping segments 14, 16, include a plurality of hollow spaces 101 which are at least partially separated from each other by ribs 102 to reinforce the clamping segments 14, 16. This may provide the clamping segments 14, 16 with a higher robustness, e.g., to enable the clamping segments 14, 16 to absorb forces, such as compression forces, without compromising the structural integrity of the clamping segments 14, 16.

FIG. 9 shows a fastening device 110 according to a further embodiment of the present disclosure. The fastening device 110 is configured similarly to the fastening device 10 shown in FIGS. 1 to 8. The features which are identical, or at least similar, bear the same reference sign(s) in FIG. 9. The fastening device 110 additionally includes a supplementary attachment device 112 configured to attach at least one additional pipe to the fastening device 110. This may increase a range of functions of the fastening device 110 by providing an attachment mechanism for said additional pipe to be attached to the fastening device 110. The additional pipe may be configured to transport one or more media therethrough, the one or more media being the same or different than the medium/media being transported by the pipe onto which the clamping device may be clamped. Preferably, the supplementary attachment device 112 may be used for auxiliary pipes, such as a liquid line in which a refrigerant, e.g., in liquid phase, such as for direct expansion refrigeration, may be transported. This may allow one or more further attachment devices, which may be required to secure the additional pipe, to be omitted which may simplify the installation.

The supplementary attachment device 112 may be configured as a clamp or clip configured to at least partially receive and secure at least a portion of the additional pipe. The supplementary attachment device 112 may be configured to fixedly receive and secure the additional pipe by means of at least one frictional connection and/or at least one form fit connection, such as an interference fit, and/or at least one material bond connection, such as an adhesive connection by means of at least one adhesive material. The supplementary attachment device 112 may be configured to fix the pipe or at least the section of the pipe, onto which the clamping device 12 may be clamped, and the additional pipe relative to each other.

Preferably, the supplementary attachment device 112 is configured such that the pipe, on which the clamping device 12 is mountable, and the additional pipe, to which the supplementary attachment device 112 is attachable, extend substantially parallel to each other, when the clamping device 12 is mounted on the pipe and the additional pipe is attached to the supplementary attachment device 112. This may allow the medium being transported in the pipe, on which the clamping device 12 is mountable, and the medium being transported in the additional pipe, to which the supplementary attachment device 112 is attachable, to being transported in substantially the same direction. This may useful when both media are to be transported to the same location or at least in substantially the same direction.

Preferably, the supplementary attachment device 112 is configured such that at least a section of the supplementary attachment device 112 is deflectable as the additional pipe is received at least partially by the supplementary attachment device 112, e.g., a clamp or clip. Preferably, as the additional pipe is being inserted into the supplementary attachment device 112, the additional pipe provides a resistance to the supplementary attachment device 112. Since the supplementary attachment device 112 is configured to be deflectable, a section of the supplementary attachment device 112 may be deflected from a starting position at least partially away from the additional pipe to a deflected position due to the resistance provided by the additional pipe. The deflected section of the supplementary attachment device 112 may then return from the deflected position towards the starting position, e.g., to the starting position, such that the supplementary attachment device 112 may provide an interlock, preferably in a clip-like and/or clamp-like manner, with the additional pipe to secure the additional pipe in the supplementary attachment device 112.

FIGS. 10 to 12 show a process for mounting the fastening device 10, 110 of any of the embodiments described above to a support structure 200. The support structure 200 is configured as a rail or rail-like structure which includes an opening or groove 202 configured to at least partially, preferably slidably, receive at least a portion of the fastening device 10, 110.

In a first step, as shown in FIG. 10, the attachment device 50 of the fastening device 10, 110 is inserted into the opening 202 and is displaced to a target position along the support structure 200. As described above with respect to FIG. 5, the attachment device 50 includes an engaging element 53 which is configured as a plate-like element having a first edge 55 with a first spatial extension E1 in a first direction and a second edge 57 with a second spatial extension E2 in a second direction, wherein the first spatial extension E1 is greater than the second spatial extension E2 and the first direction is substantially perpendicular to the second direction. Thus, the attachment device 50, more specifically the engaging element 53, is inserted with the second edge 57 leading in the direction of insertion into the groove 202, i.e., along a longitudinal axis of the groove 202. This may allow the attachment device 50, more specifically the engaging element 53, to be inserted and moved substantially freely along the groove 202 due to the smaller second spatial extension E2 of the second edge 57.

Once the attachment device 50 has reached the desired position and/or target position, the attachment device 50, more specifically the engaging element 53, may be rotated from a first rotational position to a second rotational position in which the attachment device 50 is substantially locked in place on the support structure 200, which is shown in FIG. 12. Preferably the first and second rotational positions are offset by at least 30°, preferably at least 350, more preferably at least 40°, more preferably at least 45°, more preferably at least 50°, more preferably at least 550 more preferably at least 60°, more preferably at least 65°, more preferably at least 70, more preferably at least 75°, most preferably at least 80°.

During rotation of the attachment device 50, more specifically the engaging element 53, to the second rotational position, the first spatial extension E1 may be brought into a position such that the first spatial extension E1 extends substantially perpendicular to a length of the groove 202, i.e., perpendicular to the longitudinal axis of the groove 202. Preferably, the first spatial extension E1 extends substantially perpendicularly to a length of the groove 202, i.e., perpendicularly to the longitudinal axis of the groove 202, in the second rotational position. This may facilitate locking the attachment device 50 in place on the support structure 200.

For the purpose of locking the attachment device 50, more specifically the engaging element 53, substantially in place on the support structure 200, the attachment device 50 has at least one locking portion 204 which is configured to engage with at least one counter-element 206 provided on the support structure 200 to lock the attachment device 50 in place on the support structure 200 (see FIG. 12). The locking portion 204 and the counter-element 206 may form a snap-fit connection. For this purpose, the locking portion 204 may include a tab portion 208 configured to interlock with the counter-element 206 provided on the support structure 200. The counter-element 206 may include an edge 207 of the support structure 200 which is shaped, e.g., curved and/or bent, as a lip which at least partially defines a channel 210. The tab portion 208 may be configured to be at least partially received in the channel 210 behind the lip 206 to provide an interlock between the lip 206 and the tab portion 208 (see FIG. 12).

FIG. 13 shows a system 400 for fixating a plurality of pipes 402. The system 400 includes two support structures 200A, 200B which are each configured as a rail or rail-like structure and a plurality of fastening devices 10, 110 according to any of the embodiments described above for fastening the pipes 402 to the support structures 200A, 200B.

As can be seen in FIG. 13, the fastening devices 10, 110 may be configured to support the pipes 402 in an arrangement in which the pipes 402 extend substantially vertically, i.e., substantially along the direction of gravity, in a mounted state of the fastening devices 10, 110. Alternatively, or additionally, the fastening devices 10, 110 may be configured to support the pipes 402 in an arrangement in which the pipes 402 extend substantially horizontally. Alternatively, or additionally, the fastening devices 10, 110 may be configured to support the pipes 402 in an arrangement in which the pipes 402 are oriented between a vertical and a horizontal orientation, e.g., in which the pipe extends at a 450 angle relative to a horizontal plane.

The pipes 402 and the fastening devices 10, 110 are arranged in a row. Alternatively, the pipes 402 and the fastening devices 10, 110 may be arranged in a matrix having a plurality of rows and/or columns.

The system 400 may include a compressing force generating device 406 which is configured to engage with the first support structure 200A and the second support structure 200B and exert a tensile force on the first support structure 200A and/or the second support structure 200B which may cause the support structures 200A, 200B to move relatively towards each other. Since the fastening devices 10, 110 are arranged between the support structures 200A, 200B, a pressure, e.g., a compressing force, may be exerted on the fastening devices 10, 110, e.g., to secure or clamp the fastening devices 10, 110 between the support structures 200A, 200B.

The compressing force generating device 406 may include one or more rods 407, preferably one or more threaded rods, preferably bolts, configured to engage with each of the support structures 200A, 200B, e.g., by means of a threaded connection via a screw thread providing on the rod and respective screw threads provided in a section of the support structures 200A, 200B, e.g., in an opening formed therein.

The fastening devices 10, 110 may be configured to withstand the pressure, e.g., the compressing force, exerted on the fastening devices 10, 110 by the compressing force generating device 406 without being physically compressed, i.e., shortened. However, the fastening devices 10, 110 may be compressed, i.e., shortened, by the pressure, e.g., the compressing force, exerted on the fastening devices 10, 110 by the compressing force generating device 406.

FIG. 14 shows a system 500 for fixating at least one pipe according to a further embodiment. As opposed to the system shown in FIG. 13, the system 500 of FIG. 14 includes only a single support structure 200 which is configured as a rail or rail-like structure. The system 500 includes a counter structural element 502 which is configured substantially in a U-shape. The counter structural element 502 may be a profile element, which may be formed according to the requirements of the specific application of the system 500.

The fastening device 10, 110 is mounted to the support structure 200 via the attachment device 50. The system 500 further includes a compressing force generating device 506 which includes two rods 507, preferably threaded rods, preferably bolts, configured to engage with the support structure 200 and the counter structural element 502. As described with respect to FIG. 13 above, the compressing force generating device 506 may be configured to exert a tensile force between the support structure 200 and the counter structural element 502 which may cause the support structure 200 and the counter structural element 502 to move relatively towards each other. Since the fastening device 10, 110 is arranged between the support structure 200 and the counter structural element 502, a pressure, e.g., a compressing force, may be exerted on the fastening device 10, 110, e.g., to clamp the fastening device 10, 110 between the support structure 200 and the counter structural element 502.

The compressing force generating device 506 is engaged with the counter structural element 502 via a head 512 of each of the rods 507. Moreover, the compressing force generating device 506 is engaged with the support structure 200 via fixture elements 512 which may each include a screw thread (not shown) into which each rod 507 may be screwed.

The fastening device 10, 110 may be configured to withstand the pressure, e.g., the compressing force, exerted on the fastening device 10, 110 by the compressing force generating device 506 without being physically compressed, i.e., shortened. However, the fastening device 10, 110 may be compressed, i.e., shortened, by the pressure, e.g., the compressing force, exerted on the fastening device 10, 110 by the compressing force generating device 506.

1-14. (canceled)

15. A fastening device for fastening at least one pipe to at least one support structure, including:
at least one clamping device having at least two clamp segments which are rotatably connected to each other such that the clamping device is mountable and unmountable on at least a portion of a circumference of the pipe by rotating the clamp segments relative to each other about a clamping device rotation axis;
at least one thermal insulating element made of a thermal insulating material configured to decrease a thermal transmittance of the fastening device, wherein the thermal insulating element is at least partially arranged between at least one of the clamp segments and at least a section of the pipe, when the fastening device is mounted to the pipe, and wherein the thermal insulating element is fixedly attached to at least one of the clamp segments; and
at least one attachment device configured to fixedly attach the fastening device to the support structure;
wherein the fastening device is configured such that, when the fastening device is mounted on the pipe, a first clamp segment of the plurality of clamp segments extends about a first section of the circumference of the pipe and a second clamp segment of the plurality of clamp segments extends about a second section of the circumference of the pipe, the second section being greater than the first section and the second section extending over more than half the circumference of the pipe.

16. The fastening device according to claim 15, wherein at least one of the clamp segments has an attachment section which is integrally formed on the clamp segment, the attachment section being configured to engage with at least a section of the thermal insulating element to fixedly attach the thermal insulating element to the clamp segment.

17. The fastening device according to claim 16, wherein the attachment section includes at least one protrusion which protrudes from an inner surface of the clamp segment, the inner surface facing the pipe when the fastening device is mounted on the pipe, the protrusion being configured to engage with a recess which is formed in at least a section of an outer surface of the thermal insulating element which faces the inner surface of the clamp segment, when the fastening device is mounted on the pipe to fixedly attach the thermal insulating element to the clamp segment.

18. The fastening device according to claim 17, wherein the protrusion is elongate in a direction along at least a section of the inner surface.

19. The fastening device according to claim 17, wherein the recess extends circumferentially along at least a section of the thermal insulating element.

20. The fastening device according to claim 17, wherein the protrusion is configured as a lip which extends along at least a section of the inner surface of the clamp segment, and the recess is configured as a groove which extends circumferentially along at least a section of the outer surface of the thermal insulating element, wherein the lip is configured to engage with the groove to fixedly attach the thermal insulating element to the clamp segment.

21. The fastening device according to claim 15, wherein the fastening device is configured to fasten the pipe to the support structure with said pipe extending substantially vertically.

22. The fastening device according to claim 15, including a plurality of thermal insulating elements, wherein a first thermal insulating element of the plurality of thermal insulating elements is fixedly attached to a first clamp segment of the at least two clamp segments and a second thermal insulating element of the plurality of thermal insulating elements is fixedly attached to a second clamp segment of the at least two clamp segments.

23. The fastening device according to claim 22, wherein the plurality of thermal insulating elements are detached from each other.

24. The fastening device according to claim 15, wherein the attachment device is configured to be inserted into a channel of a support structure which is configured as a rail or rail-like structure or strut.

25. The fastening device according to claim 15, wherein the attachment device is configured to engage with or be inserted into a support structure in a first orientation, and wherein the attachment device is configured to be substantially locked in place on the support structure in a second orientation, the first orientation being different from the second orientation.

26. The fastening device according to claim 25, wherein the first orientation is a first rotational position and the second orientation is a second rotational position.

27. The fastening device according to claim 25, wherein the first and second orientations are rotational positions which are offset by substantially 90° to each other.

28. The fastening device according to claim 25, wherein the attachment device is configured to be rotated from the first orientation to the second orientation by rotating at least one of the clamp segments.

29. The fastening device according to claim 28, wherein the entire fastening device is configured to be rotated to bring the attachment device from the first orientation to the second orientation to lock the attachment device in place on the support structure.

30. The fastening device according to claim 15, wherein a first end of the fastening device is provided with the attachment device and a second end of the fastening device is free of an attachment device.

31. The fastening device according to claim 30, wherein the second end is substantially opposite of the first end.

32. The fastening device according to claim 15, further including at least one indicating device configured to indicate a degree of fixture of the pipe to the support structure which is provided by the fastening device.

33. The fastening device according to claim 32, wherein the at least one indicating device is configured to visually indicate the degree of fixture of the pipe to the support structure which is provided by the fastening device.

34. The fastening device according to claim 32, wherein the degree of fixture is a level of a force provided to the fastening device by the support structure.

35. The fastening device according to claim 34, wherein the force is a compressing force.

36. A system for fixating at least one pipe, including a support structure and a fastening device according to claim 15 for fastening the pipe to the support structure.

37. The system according to claim 36, wherein the support structure is a rail or rail-like structure or strut.

38. The system according to claim 36, including a plurality of fastening devices for fastening a plurality of pipes or a plurality of sections of a pipe to the support structure, wherein each fastening device is configured to fasten a separate pipe or a separate pipe section to the support structure.

39. The system according to claim 36, including a compressing force generating device which is configured to:
engage with and exert a compressing force between at least two support structures;
or
engage with one support structure and the fastening device and exert a compressing force therebetween.
